(19) United States
(12) Patent Application Publication
(10) Pub. No.: US 2007/0128997 A1
(43) Pub. Date: Jun. 7, 2007

(54) Vehicle air duct structure

(75) Inventors: Antonio Prince, Lake Orion, MI (US); John R. Young, Royal Oak, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 11/290,483

(22) Filed: Dec. 1, 2005

(51) Int. Cl. B60J 7/22

(52) U.S. Cl. 454/129

(57) ABSTRACT

A vehicle air duct structure comprises a substantially tubular air duct body and an inner guide wall. The air duct body extends from an inlet end to an outlet end with a curved portion disposed therebetween to convey an air flow from the inlet end to the outlet end. The inner guide wall is integrally formed with the air duct body as a one-piece, unitary member. The inner guide wall is configured and arranged to separate the air flow into a plurality of branch flows in the curved portion. The air duct body further includes a generally linear portion disposed adjacent to an upstream end section of the curved portion. The inner guide wall continuously extends along a direction of the air flow in the curved portion and at least a part of the generally linear portion of the air duct body.

### BACKGROUND OF THE INVENTION

1. Field of the Invention

The present invention generally relates to a vehicle air duct structure. More specifically, the present invention relates to a vehicle air duct structure used in a vehicle air conveying system configured and arranged to convey temperature conditioned air from an air treatment device to a passenger compartment.

2. Background Information

In a conventional vehicle air conveying system that is configured and arranged to convey temperature conditioned air to a passenger compartment, an air treatment device (e.g., a heater assembly, an air-conditioning assembly, a heating, ventilation and air conditioning (HVAC) unit, and the like) is disposed forwardly of an instrument panel of the passenger compartment with respect to front to rear direction of the a vehicle cabin. In such vehicle air conveying system, a blow-molded air duct extends from the air treatment device to the passenger compartment so that temperature conditioned air from the air treatment device is conveyed to the passenger compartment through the air duct. The air duct is shaped to accommodate tight packaging conditions so that the limited space is effectively utilized while avoiding interference between the air duct and other components of the vehicle disposed in the vicinity of the air treatment device. Thus, the air duct usually includes one or more curved portions between an inlet end coupled to the air treatment device and an outlet end coupled to the passenger compartment to get around the other components disposed in the vicinity of the air treatment device.

However, when the curved portion of the air duct has a substantially large curvature (e.g., substantially at right angle), the air flow inside the air duct at the curved portion tend to be drifted toward an outer side with respect to a center of curvature of the curved portion due to inertia effect. Thus, an effective cross sectional area of the air duct is reduced and the pressure drop becomes larger at the curved portion. This pressure drop inside the air duct causes noise, vibration, and harshness (NVH) problems in the vehicle air conveying system. Moreover, when the curved portion is disposed in an immediately upstream part of the outlet end of the air duct that is coupled to a vent register, the drifted air flow passes through the curved portion and hits the vent register, thereby causing undesired noise and vibrations.

In view of the above problems, Japanese Laid-Open Patent Publication No. 2001-277836 discloses a vehicle air conditioning duct having an air directing plate disposed in a curved portion of the vehicle air conditioning duct. This reference discloses a blow molded air duct that is provided with an inwardly protruding section formed in the curved portion of the air duct. The air directing plates are inserted into the curved portion of the air duct to form an air flow guide with the inwardly protruding section at the curved portion.

However, since the air directing plate is a separate member that is inserted into the air duct, the manufacturing process of the air duct disclosed in the above mentioned reference is time consuming. Moreover, since the air flow guide is formed only in the curved portion of the air duct in the above mentioned reference, the air flow guide itself may cause undesired noise and vibration when the air flow hits the air flow guide at the curved portion.

In view of the above, it will be apparent to those skilled in the art from this disclosure that there exists a need for an improved vehicle air duct structure. This invention addresses this need in the art as well as other needs, which will become apparent to those skilled in the art from this disclosure.

### SUMMARY OF THE INVENTION

One object of the present invention is to provide a vehicle air duct structure that can improve air directionality and reduce NVH problems of the vehicle air conveying system.

In accordance with one aspect of the present invention, a vehicle air duct structure is provided that comprises a substantially tubular air duct body and an inner guide wall. The air duct body extends from an inlet end to an outlet end with a curved portion disposed therebetween to convey an air flow from the inlet end to the outlet end. The inner guide wall is integrally formed with the air duct body as a one-piece, unitary member. The inner guide wall is configured and arranged to separate the air flow into a plurality of branch flows in the curved portion.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a simplified overall perspective view of a vehicle air conveying system having a pair of air ducts in accordance with a preferred embodiment of the present invention;

FIG. 2 is an enlarged perspective view of the air duct in accordance with the preferred embodiment of the present invention;

FIG. 3 is a transverse cross sectional view of the air duct taken along a section line 3-3 of FIG. 2 in accordance with the preferred embodiment of the present invention;

FIG. 4 is a longitudinal cross sectional view of the air duct taken along a section line 4-4 of FIG. 3 in accordance with the preferred embodiment of the present invention;

FIG. 5 is a transverse cross sectional view of an air duct in accordance with a first modified structure of the preferred embodiment of the present invention; and

FIG. 6 is a longitudinal cross sectional view of an air duct in accordance with a second modified structure of the preferred embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

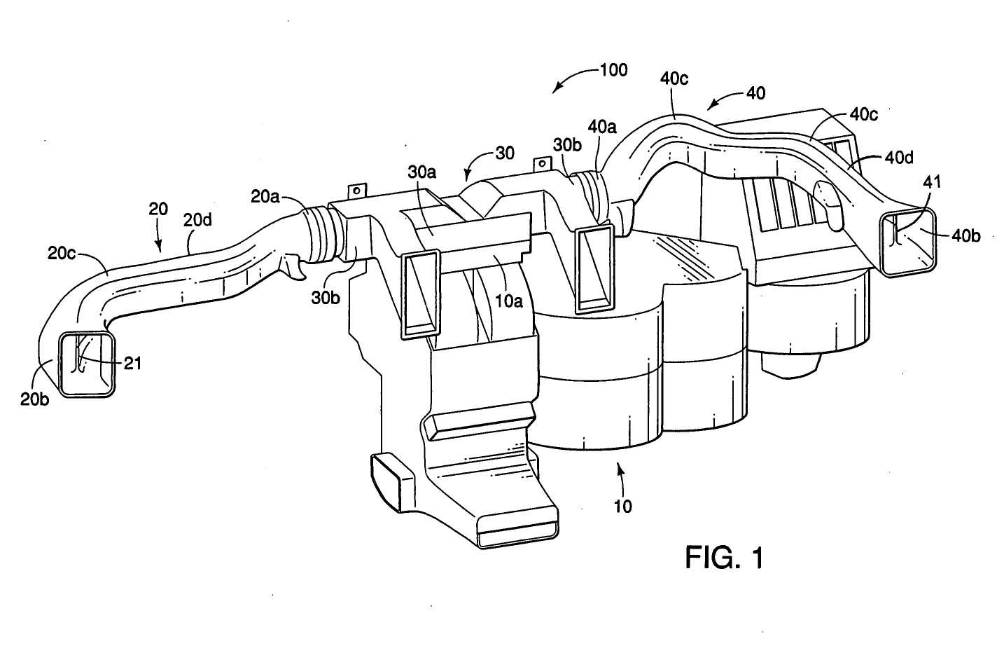

Referring initially to FIG. 1, a vehicle air conveying system 100 including a pair of (left and right) air ducts 20 and 40 is illustrated in accordance with a preferred embodiment of the present invention. The vehicle air conveying system 100 illustrated in FIG. 1 is configured and arranged to control environmental temperatures of a passenger compartment of a vehicle. The vehicle air conveying system 100 is preferably disposed forwardly of an instrument panel of the passenger compartment with respect to front to rear direction of a vehicle cabin.

As seen in FIG. 1, the vehicle air conveying system 100 basically comprises an air treatment device 10, the left and right air ducts 20 and 40, and a center vent duct 30 disposed between the air treatment device 10 and the left and right air ducts 20 and 40. The air treatment device 10 is configured and arranged to control temperature of air coming into the air treatment device 10 to provide temperature conditioned air to the passenger compartment of the vehicle. The air treatment device 10 is preferably a heating, ventilation and air conditioning (HVAC) unit that comprises conventional components such as a heater core, a blower for blowing air through the heater core, an evaporator for cooling air, and the like. The center vent duct 30 preferably includes an inlet portion 30a and a pair of outlet portions 30b with the inlet portion 30a being coupled to an outlet portion 10a of the air treatment device 10. One of the outlet portions 30b is coupled to the left air duct 20 and the other one of the outlet portions 30b is coupled to the right air duct 40. Thus, the air treatment device 10 is fluidly coupled to the left and right air ducts 20 and 40 via the center vent duct 30.

The left air duct 20 includes a substantially tubular air duct body that extends from an inlet end portion 20a to an outlet end portion 20b with a curved portion 20c and a generally linear portion 20d disposed between the inlet end portion 20a and the outlet end portion 20b . Likewise, the right air duct 40 includes a substantially tubular air duct body that extends from an inlet end portion 40a to an outlet end portion 40b with a pair of curved portions 40c and a generally linear portion 40d disposed therebetween. As used herein, a “curved portion” refers to a portion of the air duct 20 or 40 that is bent such that a direction of the air flow inside the air duct 20 or 40 is changed at least 45° in direction from the point of entrance to the point of exit of the bent or curved portion. The “generally linear portion” as used herein refers to a portion of the air duct 20 or 40 that is generally linear so that a direction of the air flow inside the air duct 20 or 40 remains substantially the same therein.

Of course, it will be apparent to those skilled in the art from this disclosure that precise structures of the left and right air ducts 20 and 40 (e.g., the positions of the curved portions 20c and 40c and the generally linear portions 20d and 40d, the number of the curved portions 20c and 40c, the curvatures of the curved portions 20c and 40c and the like) vary depending on arrangements of other components in the vicinity of the air treatment device 10 in the space where the vehicle air conveying system 100 is disposed. In other words, the shapes or contours of the air ducts 20 and 40 are designed so that they do not interfere with other components disposed in the vicinity of the air treatment device 10.

The outlet end portions 20b and 40b of the left and right air ducts 20 and 40 are configured and arranged to be respectively coupled to a vent register (not shown) that is installed in the instrument panel of the passenger compartment.

The left and right air ducts 20 and 40 are preferably formed by a conventional blow molding method. As seen in FIG. 1, the left air duct 20 has an inner guide wall 21 that is integrally formed with the left air duct 20 as a one-piece, unitary member. Likewise, the right air duct 40 has an inner guide wall 41 that is integrally formed with the right air duct 40 as a one-piece, unitary member. Each of the inner guide walls 21 and 41 is configured and arranged to separate the air flow into two branch flows at least in the curved portion (the curved portion 20c or 40c) to improve directionality of air flowing inside the air duct 20 or 40.

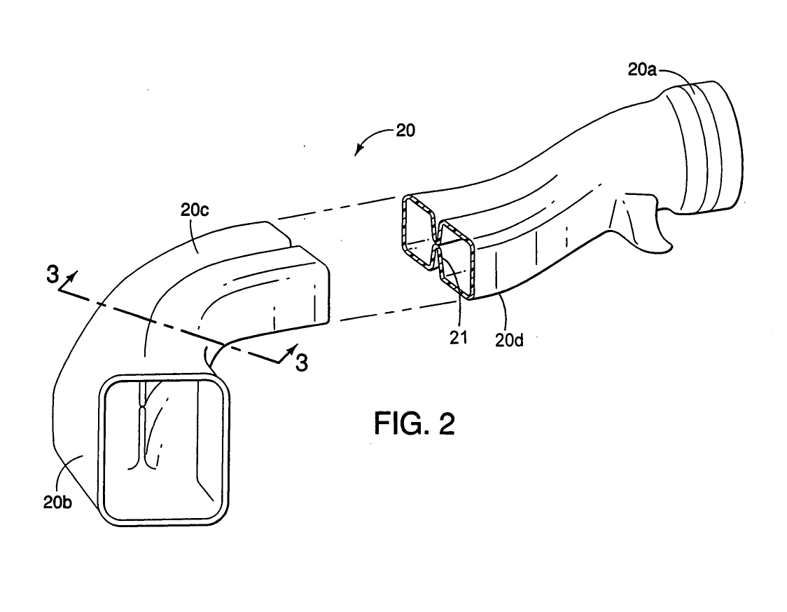

Referring now to FIGS. 2 to 5, a structure of the left air duct 20 will be explained in more detail. Since the essential features of the right air duct 40 relating to the present invention is the same as in the left air duct 20, only the structure of the left air duct 20 will be discussed in detail herein for the sake of brevity.

FIG. 2 is an enlarged partial perspective view of the air duct 20 in accordance with the preferred embodiment of the present invention. In the preferred embodiment illustrated in FIG. 2, the inner guide wall 21 extends majority of a longitudinal length of the air duct 20, while the inlet end portion 20a and the outlet end portion 20b are free of the inner guide wall 21.

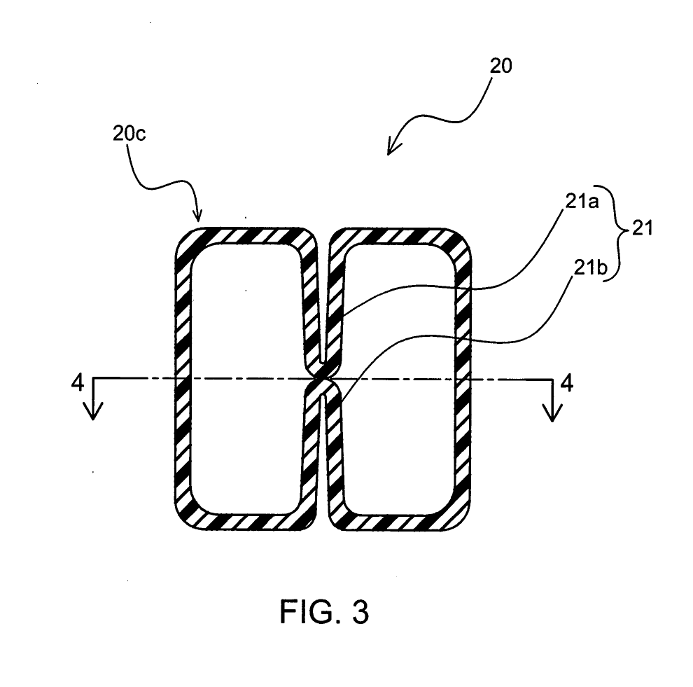

FIG. 3 is a transverse cross sectional view of the air duct 20 taken along a section line 3-3 of FIG. 2. As shown in FIG. 3, the inner guide wall 21 is integrally formed with the air duct 20 as a one-piece, unitary member. The inner guide wall 21 is preferably configured to form a pair of stand-offs extending inwardly from opposite side surfaces of the air duct 20. More specifically, the inner guide wall 21 includes a first wall portion 21a protruding inwardly from a first side (top side in FIG. 3) of the air duct 20 and a second wall portion 21b protruding inwardly from a second side (bottom side in FIG. 3) of the air duct 20. The second wall portion 21b protrudes toward the first wall portion 21asuch that an inner end of the first wall portion 21a is disposed adjacent to an inner end of the second wall portion 21b. Since the inner guide wall 21 is formed by the first wall portion 21a and the second wall portion 21b that are integrally formed with the air duct 20 as a one-piece, unitary member, the air duct 20 with the inner guide wall 21 can be manufactured in a simple manner by using the conventional blow molding method. Also, the structural rigidity of the air duct 20 can be improved by providing the inner guide wall 21 inside the air duct 20 in this manner.

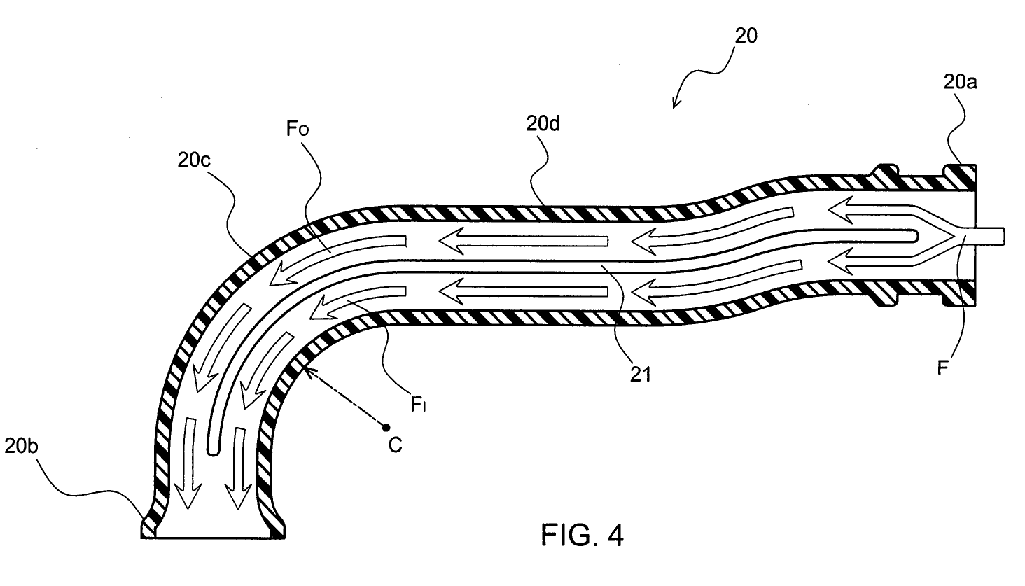

FIG. 4 is a longitudinal cross sectional view of the air duct 20 taken along a section line 4-4 of FIG. 3. As shown in FIG. 4, the inner guide wall 21 of the air duct 20 continuously extends along a direction of the air flow (i.e., a longitudinal direction of the air duct 20) in the curved portion 20c and the generally linear portion 20d. In other words, the inner guide wall 21 extends for the majority of the longitudinal length of the air duct 20 while the inlet end portion 20a and the outlet end portion 20b are free of the inner guide wall 21. Thus, when the temperature conditioned air is provided from the air treatment device 10 via the center vent duct 30, the air flow F of the temperature conditioned air blows in from the inlet end portion 20a of the air duct 20. Then, as shown in FIG. 4, the air flow F is divided into two branch flows by the inner guide wall 21. The inner guide wall 21 is arranged so that the air flow F is divided into an inner curved branch flow F_{I} and an outer curved branch flow F_{O} with respect to a center of curvature C of the curved portion 20c of the air duct 20 at the curved portion 20c of the air duct 20 as shown in FIG. 4. Thus, with the air duct 20 of the present invention, the air inside the air duct 20 is prevented from drifting toward the outer side at the curved portion 20c because the inner guide wall 21 is configured to divide the air flow F into the inner curved branch flow F_{I} and the outer curved branch flow F_{O}. Accordingly, the directionality of the air flow inside the air duct 20 is improved, thereby preventing sudden pressure drop at the curved portion 20c. Moreover, in this embodiment, since the inner guide wall 21 is continuously formed in a portion upstream of the curved portion 20c (i.e., the generally linear portion 20d), the air directionality is further improved because the air flow F is divided into the branch flows before the air flow F reaches the curved portion 20c. Accordingly, the NVH problems of the vehicle air conveying system 100 can be reduced.

In addition, the inner guide wall 21 of the present invention can be configured and arranged to change a natural frequency of the air duct 20 to suppress a vibration of the air duct 20 due to a resonance vibration during operation of the air treatment device 10. In other words, if there is some resonance frequency in the vehicle air conveying system 100, the inner guide wall 21 of the air duct 20 can be designed to change the natural frequency of the air duct 20 to avoid the NVH problems caused by the resonance vibration of the vehicle air conveying system 100. Thus, the NVH problems in the vehicle air conveying system 100 can be further reduced by providing the inner guide wall 21 in the air duct 20.

Although the first and second wall portions 21a and 21b are illustrated in FIG. 3 as having substantially the same length by which the first and second wall portions 21a and 21b protrude inwardly so that the inner ends of the first and second wall portions 21a and 21b are disposed at a substantially center portion of the air duct 20, the first and second wall portions 21a and 21b of the inner guide wall 21 are not limited to such arrangements. For example, the first and second wall portions 21a and 21b can have different lengths by which the first and second wall portions 21a and 21b protrude inwardly as long as the inner guide wall 21 is formed to separate the air flow F into the branch flows to improve the directionality of the air flow F inside the air duct 20. Moreover, although in the embodiment explained above the inner guide wall 21 is arranged to divide the cross sectional area of the air duct 20 into two substantially equal areas as shown in FIG. 3, the inner guide wall 21 is not limited to such arrangement. For example, the inner guide wall 21 can be arranged to separate the cross sectional area of the air duct 20 such that an area of an outer side of the air duct 20 and an area of an inner side of the air duct 20 with respect to the center of curvature C of the curved portion 20c are not equal depending on the shape of the air duct 20 and the desired air directionality.

Moreover, in the above explained embodiment, the inner guide wall 21 is configured and arranged to divide the air flow into two branch flows throughout the majority of the longitudinal length of the air duct 20, the arrangement of the inner guide wall 21 is not limited to such structure. Depending upon the structure or the shape of the air duct 20, a plurality of inner guide walls can be formed to divide the air flow F into more than two branch flows.

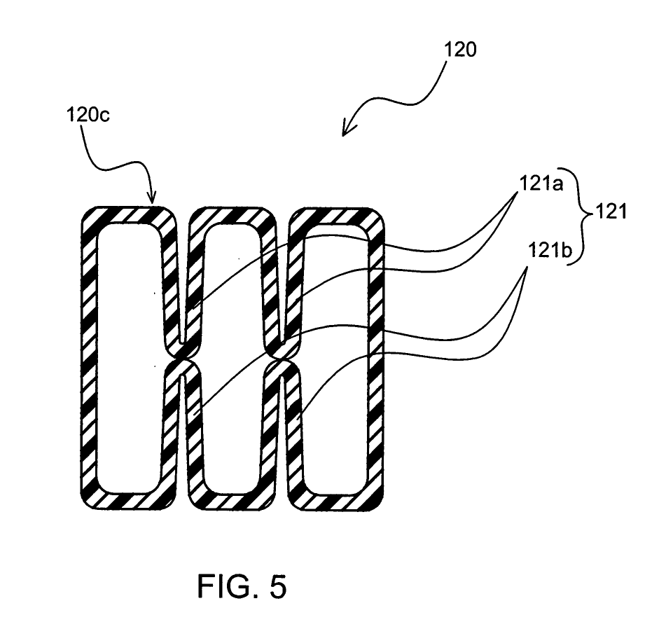

FIG. 5 is a cross sectional view of an air duct 120 in accordance with a first modified structure of the preferred embodiment of the present invention which can be used in place of the air duct 20 in FIG. 1. As seen in FIG. 5, the air duct 120 has a pair of inner guide walls 121 integrally formed with the air duct 120. In this first modified structure, each of the inner guide walls 121 includes a first wall portion 121a extending inwardly from a first side (top side in FIG. 5) of the air duct 120 and a second wall portion 121b extending inwardly from a second side (bottom side in FIG. 5) of the air duct 120 toward the first wall portion 121 a such that an inner end of the first wall portion 121a is disposed adjacent to an inner end of the second wall portion 121b. In the air duct 120 shown in FIG. 5, the air flow is divided into three branch flows at a portion where the inner guide walls 121 are formed.

Moreover, although the inner guide wall 21 is arranged to extend in the majority of the longitudinal length of the air duct 20 in the embodiment illustrated in FIGS. 1 to 4, the arrangement of the inner guide wall 21 is not limited to such structure. For example, depending on the structure or the shape of the air duct 20, the inner guide wall 21 can be formed only in the curved portion 21c and a part of the generally linear portion 21d that is adjacent to the curved portion 21c instead of the majority of the longitudinal length of the air duct 20.

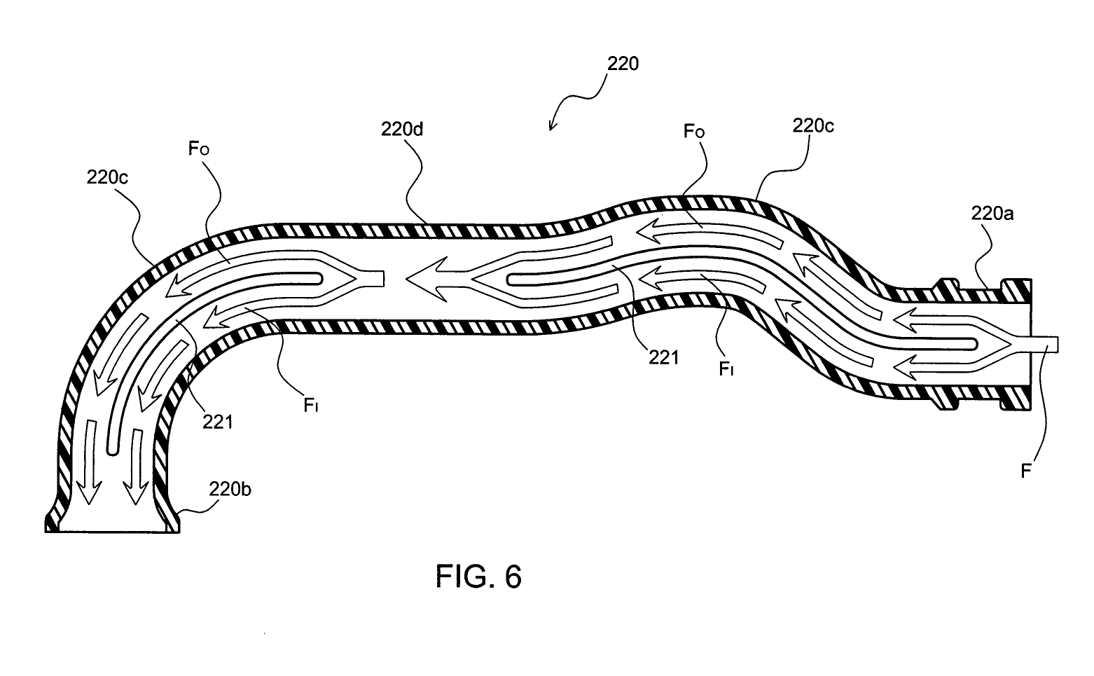

FIG. 6 illustrates an example of a second modified structure of the preferred embodiment of the present invention where an air duct 220 is provided with a plurality of curved portions 220c (i.e., two curved portions 220c) and an intermediate portion 220d disposed between the two curved portions 220c. The air duct 220 can be used in place of the air duct 20 in FIG. 1. In the air duct 220 shown in FIG. 6, the inner guide wall 221 is arranged to separate the air flow F into two branch flows (i.e., the inner curve branch flows F_{I} and the outer curve branch flows F_{O}) in the curved portions 220c while the intermediate portion 220d is free of the inner guide wall 221. The structure of the inner guide wall 221 is substantially same as the inner guide wall 21 as shown in FIG. 1.

Moreover, depending on the structure or the shape of the air duct 220 and depending on the tool capability for manufacturing the air duct 20, the inner guide wall 221 can be arranged to extend horizontally and vertically in different locations, and/or to have different lengths by which the inner guide wall 221 protrude inwardly in different locations.

Although in the above explained embodiment the air ducts 20 and 40 are used in the vehicle conveying system in which the air treatment device 10 is arranged as the HVAC unit, it will be apparent to those skilled in the art from this disclosure that the vehicle air duct structure of the present invention can be utilized with a conventional air heating device and/or a conventional air conditioning device.

As used herein to describe the above embodiment(s), the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention. The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A vehicle air duct structure comprising:
a substantially tubular air duct body extending from an inlet end to an outlet end with a curved portion disposed therebetween to convey an air flow from the inlet end to the outlet end; and
an inner guide wall integrally formed with the air duct body as a one-piece, unitary member, the inner guide wall being configured and arranged to separate the air flow into a plurality of branch flows in the curved portion, at least the outlet end of the air duct body being free of the inner guide wall so that the branch flows separated by the inner guide wall communicate at the outlet end within the air duct body.

2. The vehicle air duct structure as recited in claim 1, wherein
the inner guide wall is arranged to divide the air flow into an inner curved branch flow and an outer curved branch flow with respect to a center of curvature of the curved portion of the air duct body.

3. The vehicle air duct structure as recited in claim 1, wherein
the inner guide wall includes a first wall portion extending inwardly from a first side of the air duct body, and a second wall portion extending inwardly from a second side of the air duct body toward the first wall portion such that an inner end of the first wall portion is disposed adjacent to an inner end of the second wall portion.

4. The vehicle air duct structure as recited in claim 1, wherein
the air duct body further includes a generally linear portion disposed adjacent to an upstream end section of the curved portion, and
the inner guide wall continuously extends along a direction of the air flow in the curved portion and at least a part of the generally linear portion of the air duct body.

5. The vehicle air duct structure as recited in claim 4, wherein
the inner guide wall is arranged to divide the air flow into an inner curved branch flow and an outer curved branch flow with respect to a center of curvature of the curved portion of the air duct body.

6. The vehicle air duct structure as recited in claim 1, wherein
the inlet end of the air duct body is configured and arranged to be fluidly coupled to a vehicle air treatment device, and the outlet end of the air duct body is configured and arranged to be fluidly coupled to a passenger compartment so that the air flow from the vehicle air treatment device is conveyed to the passenger compartment through the air duct body.

7. The vehicle air duct structure as recited in claim 1, wherein
the air duct body and the inner guide wall are blow molded.

8. The vehicle air duct structure as recited in claim 1, wherein
the inlet end of the air duct body is free of the inner guide wall.

9. The vehicle air duct structure as recited in claim 1, wherein
the air duct body further includes an additional curved portion disposed between the inlet end and the outlet end with an intermediate portion extending between the curved portion and the additional curved portion, and
the inner guide wall being further configured and arranged to separate the air flow into a plurality of branch flows in the additional curved portion while the intermediate portion is free of the inner guide wall.

10. A vehicle air duct structure comprising:
a substantially tubular air duct body extending from an inlet end to an outlet end to convey an air flow from the inlet end to the outlet end, the air duct body further including a generally linear portion and a curved portion disposed adjacent to a downstream end section of the generally linear portion; and
an inner guide wall integrally formed with the air duct body and continuously extending along a direction of the air flow in the curved portion and at least a part of the generally linear portion, the inner guide wall being configured and arranged to separate the air flow into a plurality of branch flows,
at least the outlet end of the air duct body being free of the inner guide wall so that the branch flows separated by the inner guide wall communicate at the outlet end within the air duct body.

11. The vehicle air duct structure as recited in claim 10, wherein
the inner guide wall is arranged to divide the air flow into an inner curved branch flow and an outer curved branch flow with respect to a center of curvature of the curved portion of the air duct body.

12. The vehicle air duct structure as recited in claim 10, wherein
the inner guide wall includes a first wall portion extending inwardly from a first side of the air duct body, and a second wall portion extending inwardly from a second side of the air duct body toward the first wall portion such that an inner end of the first wall portion is disposed adjacent to an inner end of the second wall portion.

13. The vehicle air duct structure as recited in claim 10, wherein
the inlet end of the air duct body is configured and arranged to be fluidly coupled to a vehicle air treatment device, and the outlet end of the air duct body is configured and arranged to be fluidly coupled to a passenger compartment so that the air flow from the vehicle air treatment device is conveyed to the passenger compartment through the air duct body.

14. The vehicle air duct structure as recited in claim 10, wherein the air duct body and the inner guide wall are blow molded.

15. The vehicle air duct structure as recited in claim 10, wherein
the inlet end of the air duct body is free of the inner guide wall.

16. The vehicle air duct structure as recited in claim 10, wherein
the air duct body further includes an additional curved portion disposed between the inlet end and the outlet end with an intermediate portion extending between the curved portion and the additional curved portion, and
the inner guide wall being further configured and arranged to separate the air flow into a plurality of branch flows in the additional curved portion while the intermediate portion is free of the inner guide wall.

17-18. (canceled)

19. A vehicle air duct structure comprising:
a substantially tubular air duct body extending from an inlet end to an outlet end with a curved portion disposed therebetween to convey an air flow from the inlet end to the outlet end; and
an inner guide wall integrally formed with the air duct body as a one-piece, unitary member, the inner guide wall being configured and arranged to separate the air flow into a plurality of branch flows in the curved portion,
the inner guide wall including a first wall portion extending inwardly from a first side wall of the air duct body, and a second wall portion extending inwardly toward the first wall portion from a second side wall of the air duct body that faces the first side wall such that an inner free end of the first wall portion is disposed adjacent to an inner free end of the second wall portion.

20. The vehicle air duct structure as recited in claim 19, wherein
the inner guide wall is arranged to divide the air flow into an inner curved branch flow and an outer curved branch flow with respect to a center of curvature of the curved portion of the air duct body.

21. The vehicle air duct structure as recited in claim 19, wherein
the air duct body further includes a generally linear portion disposed adjacent to an upstream end section of the curved portion, and
the inner guide wall continuously extends along a direction of the air flow in the curved portion and at least a part of the generally linear portion of the air duct body.

22. The vehicle air duct structure as recited in claim 21, wherein
the inner guide wall is arranged to divide the air flow into an inner curved branch flow and an outer curved branch flow with respect to a center of curvature of the curved portion of the air duct body.

23. The vehicle air duct structure as recited in claim 19, wherein
the inlet end of the air duct body is configured and arranged to be fluidly coupled to a vehicle air treatment device, and the outlet end of the air duct body is configured and arranged to be fluidly coupled to a passenger compartment so that the air flow from the vehicle air treatment device is conveyed to the passenger compartment through the air duct body.

24. The vehicle air duct structure as recited in claim 19, wherein
the air duct body and the inner guide wall are blow molded.

25. The vehicle air duct structure as recited in claim 19, wherein
the inlet and outlet ends of the air duct body are free of the inner guide wall.

26. The vehicle air duct structure as recited in claim 19, wherein
the air duct body further includes an additional curved portion disposed between the inlet end and the outlet end with an intermediate portion extending between the curved portion and the additional curved portion, and
the inner guide wall being further configured and arranged to separate the air flow into a plurality of branch flows in the additional curved portion while the intermediate portion is free of the inner guide wall.
